(19) United States
(12) Patent Application Publication
(10) Pub. No.: US 2009/0095139 A1
(43) Pub. Date: Apr. 16, 2009

(54) Mobile wheelset reprofiling device

(75) Inventors: Manfred Boms, Wegberg (DE); Hans-Joachim Reiche, Erkrath (DE); Theo Nijssen, Beesel (DE)

Correspondence Address: PROSKAUER ROSE LLP, ONE INTERNATIONAL PLACE, BOSTON, MA, 02110, US

(73) Assignee: HEGENSCHEIDT-MFD GMBH & CO. KG, ERKELENZ (DE)

(21) Appl. No.: 12/279,678

(22) PCT Filed: Feb. 16, 2007
(86) PCT No.: PCT/EP07/51490

§ 371 Date: Sep. 18, 2008

(30) Foreign Application Priority Data
Feb. 16, 2006 (DE) 10 2006 007 137.9

(51) Int. Cl. B23B 5/32

(52) U.S. Cl. 82/105

(57) ABSTRACT

A mobile wheelset reprofiling device mounted on rollers which can be moved on a workshop track for reprofiling wheelsets is provided. The wheelsets are mounted in a bogie such that they can rotate. The reprofiling includes using a mobile wheelset lathe, which can be connected to a corresponding service container which is also mounted on rollers and can be moved on a workshop track. A device for supporting another wheelset which is currently not being machined is also provided. The mobile wheelset lathe, the service container and the device for supporting the wheelsets are attached to a common support frame which is mounted on rollers which can be moved in the workshop track.

### CROSS-REFERENCE TO RELATED APPLICATIONS

This application is a National Phase Application of International Application No. PCT/EP2007/051490, filed on Feb. 16, 2007, which claims the benefit of and priority to German patent application no. DE 10 2006 007 137.9-14, filed Feb. 16, 2006. The disclosure of each of the above applications is incorporated herein by reference in their entirety.

### FIELD OF THE INVENTION

The invention relates to a roller-mounted mobile wheelset processing device including a mobile wheelset lathe which can be moved along a workshop track for machining wheelsets which are mounted such that they can rotate in a rail vehicle bogie. The invention also relates to a service container which is connected to the mobile wheelset lathe via a coupling, whereby the service container is also mounted on rollers and can be moved on the workshop track. The invention also includes a device for supporting one or more wheelsets of the bogie which are not currently being machined.

### BACKGROUND OF THE INVENTION

In general, wheelset machining includes reprofiling two individual wheels as well as machining brake disks which can be on the axle shaft of the wheelset or within the wheel disks.

Mobile wheelset lathes are known, for example from DE 100 25 724 A1. In the known mobile wheelset lathes, the frame of the machine is mounted on rollers or wheels and can be driven across the floor. The known wheelset lathe is designed for reprofiling wheel disks or brake disks of a railway wheel or wheelset mounted on a rotating bearing in a bearing box. It includes a mobile support frame with a tensioning element for gripping a closed inner and/or outer bearing box of a wheelset, and support rollers, which can be pressed against the outer circumference of the wheel disk opposite to the tensioning element at alternating distances, while the tensioning element grips the bearing box of the wheel disk. The known mobile wheelset lathe also contains a drive for at least one of the two supporting rollers and a tool for machining the wheel or brake disks of the railway wheel or wheelset.

DE 20 2005 004 786 U1 also describes a machine for reprofiling the wheels and/or brake disks of rail vehicle wheelsets. A pit is dug out underground underneath the workshop track. A second track is provided at the bottom of the pit, onto which a mobile wheelset reprofiling machine can be lowered and along which it can be moved or locked. The mobile wheelset reprofiling machine can also be connected to a service container, which in turn is on wheels and can be moved along the second track in the extension of the pit. In order to compensate for possible differences in height between the mobile wheelset reprofiling machine and the service container, supports are provided, which can be pushed under a mobile wheelset lathe to allow a wheelset to be machined, and lift the latter from the workshop track in doing so.

A feature common to the known devices is that the mobile wheelset reprofiling machine and the corresponding service container can each be separated from one another and connected as required. However, this makes it difficult to dispose of chips. The mobile service container has proved unsatisfactory for removing chips which accumulate during an extended machining period, as it soon reaches the limits of its capacity. Also, horizontal height compensation between the wheelset of an unmounted bogie being machined and the wheelset to be supported is not always satisfactory, which means that a better solution is needed.

### SUMMARY OF THE INVENTION

In general, a machine in accordance with an embodiment of the invention can be used for reprofiling wheelsets which are held in an unmounted bogie. A bogie is considered to be unmounted if it is not connected to a rail vehicle when the wheelsets are machined. Bogies of this kind can be found in workshops in which rail vehicles or locomotives are serviced or in workshops in which track gauge changes are made to rail vehicles, for example, workshops at the border between France and Spain or at the border between Poland and Russia. The unmounted bogies which are found in such locations can be positioned on a wheelset lathe using a crane.

After one wheelset has been machined, the workshop crane can lift the unmounted bogie again and turn it so that the other wheelset can be processed. The present invention is not only limited to machining unmounted bogies, which are usually equipped with two wheelsets, but also unmounted bogies with more than two wheelsets. In some embodiments, the invention provides a wheelset reprofiling device for machining wheelsets which are mounted on rotating bearings in bogies which are connected to a rail vehicle, locomotive or carriage. The rail vehicle can be lifted with its bogies and the wheelset reprofiling device can be maneuvered underneath it. In certain embodiments, the wheelset reprofiling device can be lowered into a pit and the rail vehicle with its bogies can be driven along a workshop track over the wheelset reprofiled device, which allows the wheels to be machined.

Support devices are provided for supporting the wheelsets of the bogie as fixed parts of a service container, which is connected to a mobile wheelset lathe.

An advantage of the present invention is that it provides a service container for the mobile wheelset lathe. Service containers are known, for example, from DE 202 14 918 D1. A service container which is a part of the mobile wheelset reprofiling machine, is mobile and includes connection lines for power and/or control units and/or for disposing of the waste which occurs during machining, and which can be connected to the support frame of the mobile wheelset processing machine with the corresponding connections. In certain embodiments, the service container can also feature a disposal device that includes a chip conveyor and a container via which chips can be removed from the tool machine and temporarily stored in the container.

A device for supporting bogies on mobile wheelset reprofiling machines is also known for example from DE 203 19 063 D1. However, in embodiments of the invention, support is provided for the wheels of a bogie wheelset in the longitudinal direction at one bogie axle distance from the processing tools of the mobile wheelset reprofiling machine. The device for supporting the wheelset of the bogie which is not being machined is at a vertical height as required by the upper edge of the service container. A roller block which can be moved along the support holds the wheelset and can be horizontally set to the respective axle distance of the bogie.

In general, in one aspect, the present invention features attaching a device to a mobile wheelset reprofiling machine and a mobile service container which can be connected to it, which allows trouble-free disposal of accumulated chips over an extended processing period. At the same time, the support of the bogie wheelset currently not being machined was to be improved.

In another aspect, the present invention features mounting a mobile wheelset lathe, a mobile service container and a support device on a common support frame on rollers which can be moved on a workshop track.

### BRIEF DESCRIPTION OF DRAWINGS

The following section describes exemplary features of the invention.

The following illustrations depict the views in a reduced scale:

FIG. 1 shows a side view of the wheelset reprofiling device

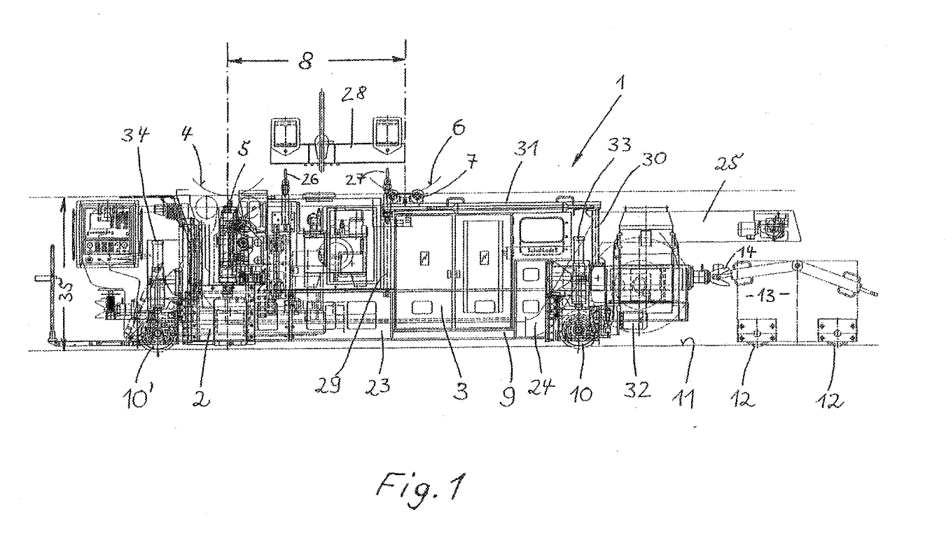

FIG. 2 shows a plan view of the wheelset reprofiling device from FIG. 1,

FIG. 3 shows a front view of the wheelset reprofiling device in a slightly larger scale compared with the illustrations in the previous figures.

### DETAILED DESCRIPTION

The mobile wheelset reprofiling device (1) includes a wheelset reprofiling machine (2) and a corresponding service container (3). The wheelset reprofiling machine (2) is designed to reprofile a wheelset (4) of a bogie (not shown). Both, the circumferential profile of the two wheel disks of the wheelset (4) as well as any brake disks (not shown) which there may be on wheelset 4 can be reprofiled. During the machining of the wheelset (4) on the wheelset reprofiling machine (2) using tools (5), the other wheelset (6) of the bogie is supported by a device (7) which can be moved horizontally along the upper side of the service container (3). The horizontal mobility of the support device (7) allows the support of the wheelset (6) currently not being reprofiled to be adapted to the respective axle distance (8).

The wheelset reprofiling machine (2) and its corresponding service container (3) are mounted on a common support frame (9) which is on rollers (10 and 10′). The rollers (10 and 10′) can be moved along a workshop track (11). A chip container (13), which can be connected to the front end of the wheelset reprofiling device (1) via a coupling (14), is also supported on rollers (12)

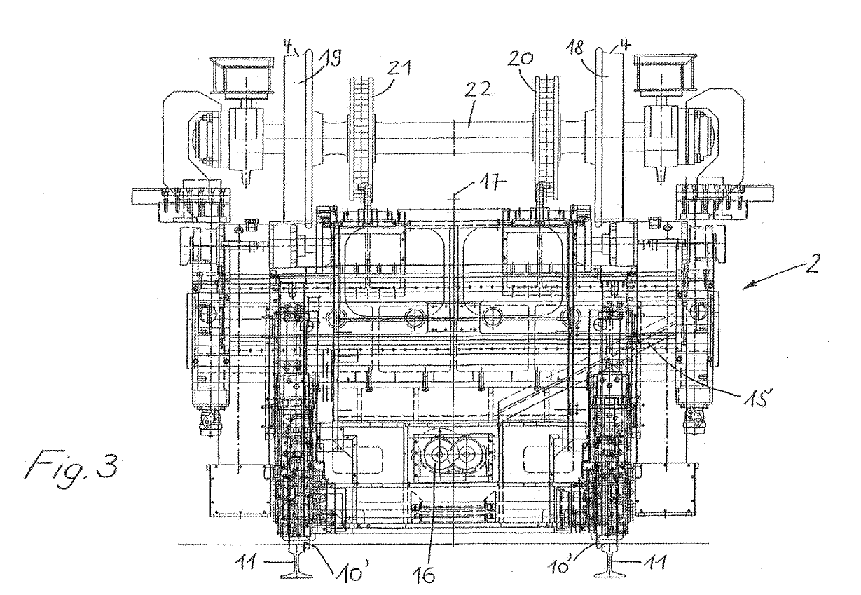

The chips which accumulate at the machining tool (5) can first slide down an angled plate or chip guidance plate to a chip crusher (16). FIG. 3 shows only one of two angled plates or chip guidance plates (15). The chip crusher (16) is in the lower section of the wheelset reprofiling machine (2) in the longitudinal centre (17) of the wheelset profiling device (1). In some embodiments, the wheelset (4) has brake disks (20 and 21), which are attached to axle shaft (22) of wheelset (4), in addition to the two wheel disks (18 and 19). A horizontal chip conveyor (23) can be provided in the extension of the chip crusher (16), which runs through the service container (3). The horizontal chip conveyor (23) opens onto a vertical conveyor (24), which in turn transitions to a horizontal section (25) above the chip container (13). After leaving the chip crusher (16), the accumulated and milled chips run under service container (3). The chips are raised to a height approaching that of the upper edge of the service container (3) by the vertical conveyor (24), and passed on to the horizontal section (25) of the conveyor route. From the end of the horizontal section (25), the milled chips fall into the chip container (13), from which they can be disposed of as required.

Lifting gear (26 and 27) is provided on the wheel reprofiling machine (2) and the service container (3) on the ends which face each other. The lifting gear (26, 27) is in turn attached relative to the entire wheelset reprofiling device (1) such that wheelset reprofiling device (1) can be lifted by a crane (28) in a virtually horizontal position. For example, the wheelset reprofiling device (1) can be lifted if the wheelset reprofiling device (1) is to be moved from one workshop track (11) to another workshop track (not shown).

Otherwise, the crane (28) can be used to lift unmounted bogies in which the wheelsets (4 and 6) are held by rotating bearings, as soon as reprofiling of the wheelset (4) is complete and the wheelset (6) is to be reprofiled. While the wheelset (6) is being machined, the wheelset (4) whose reprofiling has already been completed is supported by a supporting device (7).

Differences in the horizontal position of the two wheelsets (4 and 6), which already exist or are created in profiling can be compensated via the supports (29 and 30), which support a track (31) for the support device (7).

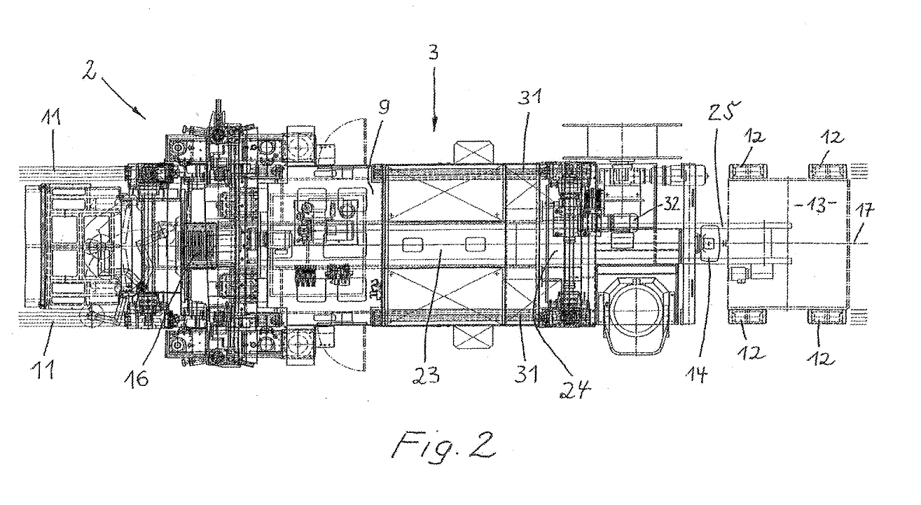

As FIG. 2 shows, the chip crusher (16), the chip conveyor (23), the vertical conveyor (24) and the horizontal section (25) of the conveyor route for the chips are aligned along the longitudinal centre (17) of the wheelset reprofiling device (1).

A travel drive (32) can be provided for the mobile wheelset reprofiling system (1) on the service container (3), which acts on the roller (10) located there. Using the travel drive (32), the mobile wheelset reprofiling system (1) can be moved along the workshop track (11). When it is moved, the roller (10′) assigned to the wheelset reprofiling machine rolls along loosely. Lifting cylinders (33 and 34) are also integrated above the rollers (10 and 10′). The lifting cylinders (33 and 34) allow the vertical working height (35) of the mobile wheelset reprofiling system (1) to be changed as desired. Such a change is useful or desired for example when the mobile wheelset reprofiling system (1) is to be moved underneath an installed bogie of a train on a stand, in order to reprofile its wheelsets. The lifting cylinders (33 and 34) can then be used to set different working heights (35) in accordance with the respective requirements of the company workshop.

### REFERENCE DRAWING LIST

1 Wheelset reprofiling device
2 Wheelset reprofiling machine or mobile wheelset lathe
3 Service container
4 Wheelset
5 Machining tool
6 Wheelset
7 Support device
8 Axle distance
9 Support frame
10 and 10′ Rollers
11 Workshop track
12 Rollers
13 Chip container
14 Coupling
15 Angled plate or chip guidance plate
16 Chip crusher
17 Longitudinal centre
18 Wheel disk
19 Wheel disk
20 Brake disk
21 Brake disk
22 Axle shaft
23 Chip conveyor
24 Vertical conveyor
25 Horizontal section
26 Lifting gear
27 Lifting gear
28 Crane
29 Support
30 Support
31 Track
32 Travel drive
33 Lifting cylinder
34 Lifting cylinder
35 Working height

1. Mobile wheelset reprofiling device for machining wheelsets wherein the wheelsets are mounted in a bogie such that the wheelsets can rotate, comprising:
a mobile wheelset lathe mounted on rollers,
a service container mounted on rollers connected to the wheelset lathe, wherein the wheelset lathe and the service container can be moved along a workshop track,
a device on the service container for supporting a wheelset of the bogie which is currently not being reprofiled, and
a common support frame mounted on rollers, wherein the mobile wheelset lathe, the service container and the device on the service container for supporting the wheelset are mounted on the common support frame which can move along the workshop track.

2. The mobile wheelset reprofiling device in accordance with claim 1 further comprising chip guidance plates and a chip crusher installed in a frame of the wheelset lathe.

3. The mobile wheelset reprofiling device in accordance with claim 2 further comprising a chip conveyor connected to the chip crusher in a frame of the service container.

4. The mobile wheelset reprofiling device in accordance with claim 3 wherein the chip crusher and the chip conveyor are located in a lower area of the wheel set lathe and the service container.

5. Mobile wheelset reprofiling device in accordance with claim 1 further comprising a chip container mounted on rollers connected via coupling to an end of the service container, wherein the chip container can be moved along the workshop track.

6. Mobile wheelset reprofiling device in accordance with claim 3 further comprising a vertical conveyor at the end of the service container for the chips carried by the chip conveyor.

7. Mobile wheelset reprofiling device in accordance with claim 6, wherein the vertical conveyor ends in a horizontal section above an upper edge of the chip container.

8. Mobile wheelset reprofiling device in accordance with claim 1 further comprising lifting gear at an end of the wheelset lathe and an end of the service container which face each other to allow the mobile wheelset reprofiling device to be lifted by a crane.

9. Mobile wheelset reprofiling device in accordance with claim 7 wherein the chip crusher, the chip conveyor, the vertical conveyor and the horizontal section of the chip conveyor are mounted along a longitudinal centre of the mobile wheelset lathe and the service container.

10. The mobile wheel set reprofiling device in accordance with claim 1 wherein vertical height of the device compared with the common support frame can be adjusted.
